(19) United States
(12) Patent Application Publication
(10) Pub. No.: US 2023/0203276 A1
(43) Pub. Date: Jun. 29, 2023

(54) MOISTURE RESISTANT POLYMER FORMULATIONS CONTAINING PHOSPHORUS-BASED FLAME RETARDANTS

(71) Applicant: J.M. Huber Corporation, Atlanta, GA (US)

(72) Inventors: Aleksey ISAROV, Kennesaw, GA (US); David Dwayne TEMPLES, Calhoun, GA (US); Yue LIU, Marietta, GA (US); Peter Charles HOHL, Kennesaw, GA (US)

(21) Appl. No.: 18/145,879

(22) Filed: Dec. 23, 2022

Related U.S. Application Data
(60) Provisional application No. 63/294,438, filed on Dec. 29, 2021.

(51) Int. Cl. C08K 5/529; C08L 23/08; C08K 9/06; C08K 3/32; C08K 3/22

(52) U.S. Cl. CPC C08K 5/529; C08L 23/0853; C08K 9/06; C08K 3/32; C08K 3/22; C08L 2201/02; C08K 2003/2227; C08K 2003/323; C08K 2201/005; C08K 2201/006

(57) ABSTRACT

Polymer compositions containing a suitable polymer and a triazine metal phosphate compound are disclosed, and the triazine metal phosphate compound can have a d50 particle size from 0.1 to 45 μm and a BET surface area from 0.5 to 30 m²/g. The polymer compositions have improved moisture resistance and improved wet insulating properties as compared to polymer compositions that contain polymerized versions of the triazine metal phosphate compound. The polymer compositions can be utilized in a variety of end-uses, such as wire and cable applications.

### REFERENCE TO RELATED APPLICATION

This application claims the benefit of U.S. Provisional Patent Application No. 63/294,438, filed on Dec. 29, 2021, the disclosure of which is incorporated herein by reference in its entirety.

### BACKGROUND OF THE INVENTION

The present invention is directed generally to polymer compositions containing flame retardant additives, and more particularly, to polymer compositions containing triazine metal phosphate flame retardants which impart improved moisture resistance.

### SUMMARY OF THE INVENTION

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

Polymer compositions or formulations containing triazine metal phosphate compounds are disclosed and described herein. A representative composition can contain a suitable polymer and a triazine metal phosphate compound having formula (I): (A−H)ₐ⁽⁺⁾[M_{b}^{m+}(H₂PO₄)ₓ₁⁽⁻⁾(HPO₄)ₓ₂²⁽⁻⁾]^{(a-)}*pH₂O. In formula (I), each M independently can be Cu, Mg, Ca, Zn, Mn, Fe, Co, Ni, B, Si, Al, Sb, La, Ti, Zr, Ce, V, or Sn, a can range from 1 to 6, b can range from 1 to 14, m can range from 1 to 6, x₁ can range from 1 to 12, x₂ can range from 0 to 12, p can range from 0 to 5, a+mb=x₁+2x₂, and each (A−H)⁽⁺⁾ independently can be a triazine derivative having formula (II-1), (II-2) or (II-3):

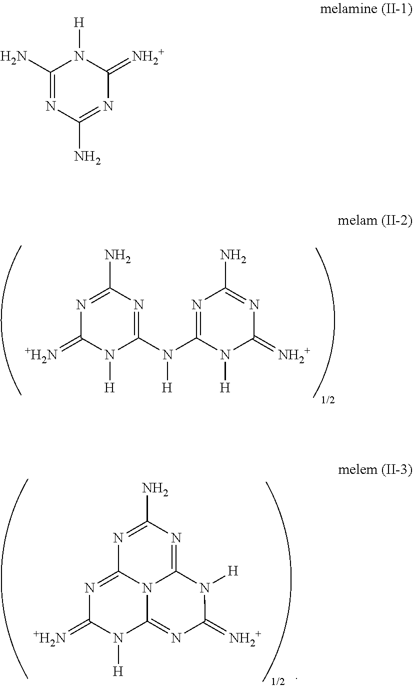

The polymer compositions provide flame retardancy and can be used in wire and cable and other end-use flame retardant polymer applications.

Both the foregoing summary and the following detailed description provide examples and are explanatory only. Accordingly, the foregoing summary and the following detailed description should not be considered to be restrictive. Further, features or variations may be provided in addition to those set forth herein. For example, certain aspects may be directed to various feature combinations and sub-combinations described in the detailed description.

### BRIEF DESCRIPTION OF THE FIGURES

FIG. 1 presents a bar chart of the water absorption at 90° C. and 14 days for the polymer compositions of Examples 1-4.

FIG. 2 presents a bar chart of the water absorption at 75° C. and 7 days for the polymer compositions of Examples 1-2 and 4-5.

FIG. 3 presents a bar chart of the dielectric constant (Dk) at 100 MHz before and after aging in water at 90° C. and 14 days for the polymer compositions of Examples 1-4.

FIG. 4 presents a bar chart of the ΔDk, based on the Dk at 100 MHz before and after aging in water at 90° C. and 14 days in FIG. 3, for the polymer compositions of Examples 1-4.

FIG. 5 presents a bar chart of the dissipation factor (Df) at 100 MHz before and after aging in water at 90° C. and 14 days for the polymer compositions of Examples 1-4.

FIG. 6 presents a bar chart of the ΔDf, based on the Df at 100 MHz before and after aging in water at 90° C. and 14 days in FIG. 5, for the polymer compositions of Examples 1-4.

FIG. 7 presents a bar chart of the dielectric constant (Dk) at 100 MHz before and after aging in water at 75° C. and 7 days for the polymer compositions of Examples 1-2 and 4-6.

FIG. 8 presents a bar chart of the ΔDk, based on the Dk at 100 MHz before and after aging in water at 75° C. and 7 days in FIG. 7, for the polymer compositions of Examples 1-2 and 4-6.

FIG. 9 presents a bar chart of the dissipation factor (Df) at 100 MHz before and after aging in water at 75° C. and 7 days for the polymer compositions of Examples 1-2 and 4-6.

FIG. 10 presents a bar chart of the ΔDf, based on the Df at 100 MHz before and after aging in water at 75° C. and 7 days in FIG. 9, for the polymer compositions of Examples 1-2 and 4-6.

FIG. 11 presents heat release rate (HRR) curves for the polymer compositions of Examples 1-2 and 4.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and each and every feature disclosed herein, all combinations that do not detrimentally affect the designs, compositions, processes, or methods described herein are contemplated and can be interchanged, with or without explicit description of the particular combination. Accordingly, unless explicitly recited otherwise, any aspect or feature disclosed herein can be combined to describe inventive designs, compositions, processes, or methods consistent with the present disclosure.

While compositions and methods are described herein in terms of “comprising” various components or steps, the compositions and methods also can “consist essentially of” or “consist of” the various components or steps, unless stated otherwise. The terms “a,” “an,” and “the” are intended to include plural alternatives, e.g., at least one, unless otherwise specified.

Generally, groups of elements are indicated using the numbering scheme indicated in the version of the periodic table of elements published in Chemical and Engineering News, 63(5), 27, 1985. In some instances, a group of elements can be indicated using a common name assigned to the group; for example, alkali metals for Group 1 elements, alkaline earth metals for Group 2 elements, and so forth.

The term “contacting” is used herein to refer to materials or components which can be blended, mixed, slurried, dissolved, reacted, treated, compounded, or otherwise contacted or combined in some other manner or by any suitable method. The materials or components can be contacted together in any order, in any manner, and for any length of time, unless otherwise specified.

Although any methods and materials similar or equivalent to those described herein can be used in the practice or testing of the invention, the typical methods and materials are herein described.

All publications and patents mentioned herein are incorporated herein by reference in their entirety for the purpose of describing and disclosing, for example, the constructs and methodologies that are described in the publications and patents, which might be used in connection with the presently described invention.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. As a representative example, the amount of the triazine metal phosphate compound in a polymer composition or formulation can be in certain ranges in various aspects of this invention. By a disclosure that the amount of the triazine metal phosphate compound in the polymer composition or formulation can be in a range from 1 to 80 wt. %, the intent is to recite that the amount of the triazine metal phosphate compound can be any amount within the range and, for example, can be in any range or combination of ranges from 1 to 80 wt. %, such as from 1 to 65 wt. %, from 1 to 40 wt. %, from 1 to 25 wt. %, from 1 to 15 wt. %, from 2 to 20 wt. %, or from 2 to 15 wt. %, and so forth. Likewise, all other ranges disclosed herein should be interpreted in a manner similar to this example.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

### DETAILED DESCRIPTION OF THE INVENTION

Disclosed herein are flame retardant polymer formulations containing a triazine metal phosphate compound, and such polymer formulations have improved moisture resistance for use in wire/cable applications.

Safire® 200, Safire® 400, and Safire® 600 are melamine poly(aluminum phosphate), melamine poly(zinc phosphate), and melamine poly(magnesium phosphate) flame retardants, respectively. As a skilled artisan would readily recognize, such phosphorus-based flame retardants are typically not utilized in certain end-use applications in which water or moisture may be present, due to absorption or pick-up of the moisture. Thus, one objective of this invention is to produce a polymer formulation having the same ASTM E1354 flame retardant performance as a formulation containing these melamine poly(metal phosphates), but with improved moisture resistance.

A particular end-use for flame retardant polymer formulations that requires moisture resistance is wire/cable applications. In wire/cable applications, the flame retardant polymer formulation is often used as an insulating layer in a multilayer wire/cable construction. Thus, the flame retardant polymer formulation acts as an insulator. Insulation resistance can be defined as the alternating-current resistance between two electrical conductors or two systems of conductors that are separated by an insulating material or layer. Cable insulation resistance of a polymer formulation can depend upon factors such as temperature, material purity, and humidity (amount of moisture present). The humidity of the environment in which electrical cables are utilized has a large impact on the insulation performance of the cable, because when the humidity increases or when the cable is in contact with liquid water, the cable can absorb water and thus the resistance can change accordingly. It is, therefore, another object of the invention to produce a polymer formulation that is impacted less by humidity (moisture), such that the insulative performance of the polymer layer in a wire/cable construction is improved.

### Triazine Metal Phosphate Compounds

Consistent with aspects of the present invention, the polymer compositions disclosed herein contain a triazine metal phosphate compound, which has formula (I):

(A−H)ₐ⁽⁺⁾[M_{b}^{m+}(H₂PO₄)ₓ₁⁽⁻⁾(HPO₄)ₓ₂²⁽⁻⁾]^{(a-)}*pH₂O (I).

Within formula (I), (A−H), M, a, b, m, x₁, x₂, and p are independent elements of the triazine metal phosphate compound, and a, b, m, x1, and x2 are integers, while p can be a fraction. Accordingly, the triazine metal phosphate compound having formula (I) can be described using any combination of (A−H), M, a, b, m, x₁, x₂, and p disclosed herein, subject to an overall charge balance of the compound. Unless otherwise specified, formula (I) above, any other structural formulas disclosed herein, and any triazine metal phosphate compound disclosed herein are not designed to show stereochemistry or isomeric positioning of the different moieties (e.g., these formulas are not intended to display cis or trans isomers, or R or S diastereoisomers), although such compounds are contemplated and encompassed by these formulas and/or structures.

In accordance with one aspect of this invention, each metal in formula (I), M, independently is Cu, Mg, Ca, Zn, Mn, Fe, Co, Ni, B, Si, Al, Sb, La, Ti, Zr, Ce, V, or Sn. In another aspect, each M independently is Ca, Mg, Zn, Al, or Sn, while in yet another aspect, each M is Ca; alternatively, each M is Mg; alternatively, each M is Zn; alternatively, each M is Al; or alternatively, each M is Sn. In formula (I), m is the oxidation state of the metal M, and depending upon the metal and its respective oxidation state(s), m can range from 1 to 6 (inclusive). In some aspects, m is from 1 to 5 or from 1 to 4, while in other aspects, m ranges from 2 to 6, from 2 to 4, or from 2 to 3. In formula (I), b is the number of metal(s) M in the triazine metal phosphate compound, and b can range from 1 to 14. This encompasses circumstances where only one metal ion or atom is present or two or more metal ions or atoms are present in the triazine metal phosphate compound. Often, b ranges from 1 to 10, from 1 to 8, from 1 to 5, from 1 to 3, from 2 to 10, or from 2 to 5, although not limited thereto. Even if only one metal is present in formula (I), b can be greater than 1 (e.g., 2, 3, 4, etc.) in order to properly balance the charges of the phosphate moieties and triazine moieties.

The number of H₂PO₄ moieties in formula (I) is x₁ and the number of HPO₄ moieties in formula (I) is x₂, and x₁ ranges from 1 to 12 and x₂ ranges from 0 to 12. For instance, x₁ can range from 1 to 8, from 1 to 6, from 1 to 5, from 1 to 4, from 1 to 3, or from 1 to 2, while x₂ can range from 0 to 8, from 0 to 6, from 0 to 4, or from 0 to 2 (x₂ equals 0, 1, or 2). In a particular aspect contemplated herein, x₁ ranges from 1 to 6 (or from 1 to 5, or from 1 to 4, or from 1 to 3) and x₂ is equal to 0 or 1.

The presence of p in formula (I) encompasses hydrate versions of the triazine metal phosphate compound, and p can range from 0 to 5, such as p ranging from 0 to 3 or from 0 to 2, and where p is equal to 0, p is equal to 1, p is equal to 2, and so forth.

In formula (I), each (A−H) independently is a triazine derivative having formula (II-1), (II-2) or (II-3):

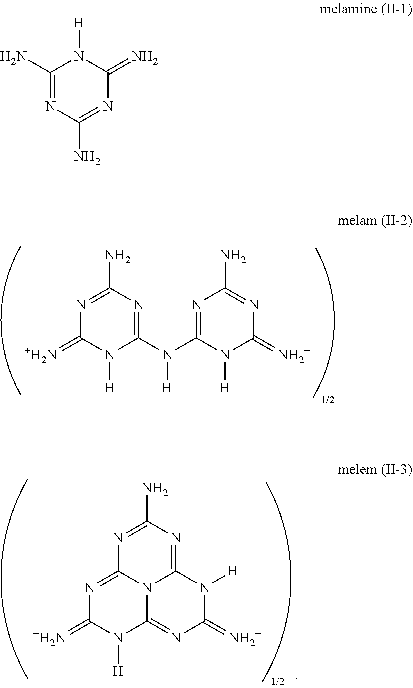

While the triazine metal phosphate compound of formula (I) consistent with this invention is not polymerized, depending upon the conditions in which the triazine metal phosphate compound is prepared (e.g., including a drying step), it is possible to have 2 or more of melamine, melam, and/or melem present. In formula (I), a is the number of triazine derivative(s) in the triazine metal phosphate compound, and a can range from 1 to 6. This encompasses circumstances where only one triazine derivative is present or two or more triazine derivatives are present in the triazine metal phosphate compound. Often, a ranges from 1 to 5, from 1 to 4, from 1 to 3, or from 1 to 2, although not limited thereto. Even if only one triazine derivative is present in formula (I), a can be greater than 1 (e.g., 2 or more) in order to properly balance the charges of the metal(s) and phosphate moieties. As an overall charge balance of the triazine metal phosphate compound, a+mb=x₁+2x₂ in formula (I).

In an aspect of the invention, the metal M is zinc, and therefore the triazine metal phosphate compound is a triazine zinc phosphate compound. While not limited thereto, the triazine zinc phosphate compound can have at least one of the following formulas:

(A−H)⁽⁺⁾[Zn²⁽⁺⁾(H₂PO₄)⁽⁻⁾(HPO₄)²⁽⁻⁾]*pH₂O

(A−H)⁽⁺⁾[Zn₂²⁽⁺⁾(H₂PO₄)₃⁽⁻⁾]*pH₂O;

(A−H)₂⁽⁺⁾[Zn²⁽⁺⁾(H₂PO₄)₂⁽⁻⁾(HPO₄)²⁽⁻⁾]*pH₂O

(A−H)₂⁽⁺⁾[Zn²⁽⁺⁾(H₂PO₄)₄⁽⁻⁾]*pH₂O;

(A−H)₂⁽⁺⁾[Zn²⁽⁺⁾(HPO₄)₂²⁽⁻⁾]*pH₂O

(A−H)⁽⁺⁾[Zn₂²⁽⁺⁾(H₂PO₄)⁽⁻⁾(HPO₄)₂²⁽⁻⁾]*pH₂O

(A−H)⁽⁺⁾[Zn₂²⁽⁺⁾(H₂PO₄)₃⁽⁻⁾(HPO₄)²⁽⁻⁾]pH₂)

(A−H)⁽⁺⁾[Zn₂²⁽⁺⁾(H₂PO₄)₅⁽⁻⁾]*pH₂O

(A−H)₂⁽⁺⁾[Zn₂²⁽⁺⁾(H₂PO₄)₂⁽⁻⁾(HPO₄)₄^{2(-)]*pH}₂O

(A−H)₂⁽⁺⁾[Zn₂²⁽⁺⁾(H₂PO₄)₄⁽⁻⁾(HPO₄)^{2(-)]*pH}₂O

(A−H)₂⁽⁺⁾[Zn₂²⁽⁺⁾(HPO₄)₃²⁽⁻⁾]*pH₂O

(A−H)₂⁽⁺⁾[Zn₂²⁽⁺⁾(H₂PO₄)₆⁽⁻⁾]*pH₂O.

The triazine zinc phosphate compound, therefore, can be a compound having any one of these formulas, or the triazine zinc phosphate compound can be a mixture of compounds having any two or more of these formulas. The presence of p in these formulas used to describe the triazine zinc phosphate compound has the same meaning as in formula (I), and thus encompasses hydrate versions of the triazine zinc phosphate compound. Therefore, p can range from 0 to 5, such as from 0 to 3 or from 0 to 2, and p can be equal to 0, equal to 1, equal to 2, and so forth.

The triazine metal phosphate compound is not limited solely to triazine metal phosphate compounds such as described above in relation to formula (I). Other suitable triazine metal phosphate compounds encompassed by formula (I) are disclosed, for example, in U.S. Pat. Nos. 8,754,154 and 10,351,776. General methods for making the triazine metal phosphate compounds also are described in these patents. The particle size of the triazine metal phosphate compound used in the polymer compositions described herein is not particularly limited, however, the triazine metal phosphate compound often can have a median particle size (d50) in a range from 0.1 to 45 μm. It can be advantageous for the triazine metal phosphate compound to have a smaller d50 particle, and therefore, suitable ranges for the d50 particle size of the triazine metal phosphate compound include from 0.5 to 20 μm, from 0.5 to 10 μm, from 1 to 6 μm, or from 1 to 5 μm, and the like. While not wishing to be bound by theory, it is believed that if the particle size of the triazine metal phosphate compound is too coarse, the particles— when present, for example, in a flame retardant polymer formulation for wire/cable applications—can act as failure points for both mechanical failure and electrical failure (e.g., sparking).

Similarly, the BET surface area of the triazine metal phosphate compound is not particularly limited, but generally falls within a range from 0.5 to 30 m²/g. Representative and non-limiting ranges for the BET surface area include from 0.5 to 10 m²/g, from 1 to 15 m²/g, from 1 to 10 m²/g, from 2 to 8 m²/g, or from 2 to 5 m²/g, and the like. Other appropriate particle sizes and surface areas for the triazine metal phosphate compound are readily apparent from this disclosure.

### Polymer Compositions

This invention is directed to, and encompasses, any compositions, formulations, composites, and articles of manufacture that contain any of the triazine metal phosphate compounds (and their respective characteristics or features, such as surface area, particle size, and so forth). In a particular aspect of this invention, a polymer composition is disclosed, and in this aspect, the polymer composition can comprise any suitable polymer (one or more than one) and any of the triazine metal phosphate compounds having formula (I) disclosed herein. In one aspect, for instance, the polymer in the polymer composition can comprise an elastomer, while in another aspect, the polymer can comprise a thermoplastic polymer, and in yet another aspect, the polymer can comprise a thermoset polymer.

The polymer used in the polymer composition with the triazine metal phosphate compound can comprise any suitable rubber or elastomer, either singly or in any combination, and non-limiting examples can include a natural rubber (NR), an epoxidized natural rubber (ENR), a synthetic cis-polyisoprene (IR), an emulsion styrene butadiene rubber (ESBR), a solution styrene butadiene rubber (SSBR), a polybutadiene rubber (BR), a butyl rubber (IIR/CIIR/BIIR), a chloroprene rubber (CR), a nitrile elastomer (NBR), a hydrogenated nitrile elastomer (HNBR), a carboxylated nitrile elastomer (XNBR), an ethylene propylene rubber (EPM/EPDM), a fluoroelastomer (FPM/FKM), a polyurethane rubber (AU/EU/PU), and the like. Combinations of two or more of these elastomer materials also can be utilized.

In an aspect, the polymer in the polymer composition can comprise a polyolefin. In another aspect, the polymer can comprise, either singly or in any combination, a polyethylene (e.g., an ethylene homopolymer or an ethylene-based copolymer, such as an ethylene/α-olefin copolymer, which can often be referred to as a LLDPE, and the like), a polypropylene (e.g., a propylene homopolymer or a propylene-based copolymer, and the like), and/or an ethylene/vinyl acetate (EVA) copolymer.

Optionally, any of these polymers can be crosslinked. For example, the polymer can comprise a crosslinked polyethylene, and the technique for crosslinking can include any suitable methodology, such as peroxide-initiated crosslinking.

In an aspect, the polymer can comprise an epoxy resin. For instance, the polymer can comprise, either singly or in any combination, a bisphenol A epoxy resin, a bisphenol F epoxy resin, a bisphenol S epoxy resin, a phenol novolac epoxy resin, a cresol novolac epoxy resin, a bisphenol A novolac epoxy resin, a bisphenol F novolac epoxy resin, a diphenylethylene epoxy resin, an epoxy resin having a triazine skeleton (e.g., a bismaleimide triazine-epoxy, which is a mixture of an epoxy resin and a bismaleimide-triazine resin), an epoxy resin having a fluorene skeleton, a triphenylmethane epoxy resin, a biphenyl epoxy resin, a xylylene epoxy resin, a biphenyl aralkyl epoxy resin, a naphthalene epoxy resin, a dicyclopentadiene epoxy resin, and/or an alicyclic epoxy resin. Generally, any epoxy resin that is suitable for use in a copper clad laminate or related application can be used as the base polymer in the polymer compositions encompassed herein.

While not being limited thereto, the amount of the triazine metal phosphate compound in the polymer composition often can range from 1 to 80 wt. %. Illustrative and non-limiting amounts of the triazine metal phosphate compound in the polymer composition, therefore, can include the following ranges: from 1 to 65 wt. %, from 1 to 40 wt. %, from 3 to 40 wt. %, from 10 to 40 wt. %, or from 3 to 25 wt. %. Other appropriate ranges for the amount of the triazine metal phosphate compound in the polymer composition are readily apparent from this disclosure.

Often, the polymer composition further includes an additional flame retardant compound (other than the triazine metal phosphate compound). Thus, the polymer composition can contain a polymer, a triazine metal phosphate compound, and an additional flame retardant compound. Any suitable flame retardant compound can be used, an example of which is a metal hydroxide, such as aluminum trihydrate (ATH), magnesium hydroxide (MDH), and the like. Combinations of metal hydroxides and additional flame retardant compounds can utilized in the polymer composition.

When present, the amount of the additional flame retardant compound in the polymer composition can range from 10 to 80 wt. % in one aspect, from 20 to 70 wt. % in another aspect, from 30 to 65 wt. % in yet another aspect, and from 40 to 60 wt. % in still another aspect. When the additional flame retardant compound is present in the polymer composition, ordinarily the amount of the triazine metal phosphate compound in the polymer composition is less than that disclosed above, and a typical range for the amount of the triazine metal phosphate compound in the polymer composition (when an additional flame retardant such as ATH and/or MDH is present) is from 1 to 40 wt. %; alternatively, from 1 to 25 wt. %; alternatively, from 1 to 15 wt. %; alternatively, from 2 to 20 wt. %; or alternatively, from 5 to 15 wt. %.

Optionally, the polymer composition can further comprise any suitable additive, non-limiting examples of which can include a stabilizer or antioxidant, a lubricant or process aid, a compatibilizer or coupling agent, a filler, a colorant, a rheology modifier, or a curing agent, and the like, as well as combinations thereof.

The polymer compositions disclosed herein, which contain any of the triazine metal phosphate compounds having formula (I), also can be characterized by the beneficial features or properties of the flame retardant composition. An example of this is a low water absorption value, quantified using ASTM D570 at 90° C. and 14 days in water. Under such test conditions, the polymer composition—containing the triazine metal phosphate compound having formula (I)—often has a water absorption of less than or equal to 6 wt. %, and in some aspects, less than or equal to 5 wt. %, less than or equal to 4 wt. %, or less than or equal to 3 wt. %.

This low water absorption is unexpected, given the much higher water absorption of a polymerized version of the triazine metal phosphate compound. Surprisingly, the polymer composition, containing the triazine metal phosphate compound having formula (I), has a water absorption, per ASTM D570 at 90° C. and 14 days in water, that is less than that of an otherwise identical formulation containing a polymerized version of the triazine metal phosphate compound. A polymerized version of the precursor triazine metal phosphate compound can be prepared as generally described in U.S. Pat. Nos. 8,754,154 and 10,351,776. It is believed that this polymerization step improves the thermal stability of the polymerized compound as compared to the precursor, such that the polymerized compound can be utilized in higher temperature applications. Herein, a polymerized version means that the (precursor) triazine metal phosphate compound has been subjected to temperature of 310° C. for a time period of 45 min.

Additionally or alternatively, the polymer composition, containing the triazine metal phosphate compound, also can have a water absorption, per ASTM D570 but at 75° C. and 7 days in water, that is less than that of an otherwise identical formulation containing a polymerized version of the triazine metal phosphate compound.

Another unexpected benefit of the disclosed polymer compositions is excellent wet insulating properties. One parameter that can be used to quantify this benefit is the dielectric constant, Dk, which increases when moisture within the polymer composition is increased. Using ASTM D150 and 100 MHz, the polymer composition—containing the triazine metal phosphate compound having formula (I)—can be characterized by a ΔDk of less than or equal to 9%, and more often, a ΔDk of less than or equal to 7%, less than or equal to 4%, or less than or equal to 2%. The ΔDk is the percentage change from an initial Dk (no aging) to Dk after aging in water at 90° C. and 14 days as described in ASTM D150.

Similarly, another parameter than can be used to quantify the beneficial wet insulating properties is the dissipation factor, Df. The dissipation factor relates to the ability of a material to hold energy or to behave as an insulating material. The lower the dissipation factor, the more efficient the material is as an insulator. Most plastics have relatively lower dissipation factors at room temperature. The dissipation factor also can be used to assess the characteristics or quality of an insulating material in applications such as cable, terminations, joints, etc., for moisture content, deterioration, and the like. Thus, upon exposure to moisture over extended periods of time, it is beneficial for the Df of an insulative material to increase only minimally.

Using ASTM D150 and 100 MHz, the polymer composition—containing the triazine metal phosphate compound having formula (I)—can be characterized by a ΔDf of less than or equal to 500%, and more often, a ΔDf of less than or equal to 400%, less than or equal to 300%, or less than or equal to 200%. The ΔDf is the percentage change from an initial Df (no aging) to Df after aging in water at 90° C. and 14 days as described in ASTM D150.

These properties are significant improvements over the polymerized triazine metal phosphate compound. In particular, the polymer composition containing the triazine metal phosphate compound having formula (I) can have a ΔDk (or a ΔDf, or both) that is less than that of an otherwise identical formulation containing a polymerized version of the triazine metal phosphate compound. These are compared under the same conditions, namely, aging in water at 90° C. and 14 days, in accordance with ASTM D150 at 100 MHz.

The benefits of the polymer composition containing the triazine metal phosphate compound having formula (I) also can be quantified using lower temperatures and less aging time. For instance, the polymer composition can be characterized by a ΔDf of less than or equal to 250%, and more often, a ΔDf of less than or equal to 225%, less than or equal to 200%, or less than or equal to 150%. This ΔDf is the percentage change from an initial Df (no aging) to Df after aging in water at 75° C. and 7 days as described in ASTM D150 (and at 100 MHz).

Even using lower temperatures and less aging time, the improvements over the polymerized triazine metal phosphate compound are readily apparent. Thus, the polymer composition containing the triazine metal phosphate compound having formula (I) can have a ΔDk (or a ΔDf, or both) that is less than that of an otherwise identical formulation containing a polymerized version of the triazine metal phosphate compound. This comparison uses the same test conditions of aging in water at 75° C. and 7 days, in accordance with ASTM D150 at 100 MHz.

The above described moisture resistance and wet insulation properties (e.g., water absorption, dielectric constant, dissipation factor) of the polymer composition are applicable to polymer compositions containing any relative amount of polymer in the composition (as compared to the amount of flame retardant(s) and other non-polymer additives). However, the moisture resistance and wet insulation properties are particularly beneficial for polymer compositions containing approximately 30 to 40 wt. % polymer, such as polymer compositions containing from 30 to 38 wt. % polymer, from 32 to 40 wt. % polymer, from 32 to 38 wt. % polymer, and the like. Accordingly, polymer compositions having any water absorption properties disclosed herein (per ASTM D570), and any ΔDk properties disclosed herein (per ASTM D150), and any ΔDf properties disclosed herein (per ASTM D150), can be polymer compositions that contain from 30 to 40 wt. % polymer, from 30 to 38 wt. % polymer, from 32 to 40 wt. % polymer, from 32 to 38 wt. % polymer, etc. Any suitable polymer(s), as described above, can be the polymer component of the polymer composition; however, polyolefins such as ethylene homopolymers, ethylene/α-olefin copolymers, propylene homopolymers, propylene-based copolymers, ethylene/vinyl acetate (EVA) copolymers—either singly or in any mixture or combination—are often utilized in the polymer composition, depending upon the subsequent article of manufacture and the end-use application.

Articles of manufacture can be formed from and/or can comprise any of the polymer compositions described herein. In one aspect, the article of manufacture can comprise a wire or cable, while in another aspect, the article can comprise a printed circuit board. Other appropriate articles of manufacture and end-use applications are readily apparent from this disclosure.

If desired, closed packing technology can be applied to the triazine metal phosphate compound, such as, for instance, combinations of larger particles of the triazine metal phosphate compound with smaller particles of the triazine metal phosphate compound (e.g., a bimodal particle size distribution) instead of a single particle size distribution. This can improve compound viscosity at very high loading levels (up to 80 wt. %, or more).

### EXAMPLES

The invention is further illustrated by the following examples, which are not to be construed in any way as imposing limitations to the scope of this invention. Various other aspects, modifications, and equivalents thereof which, after reading the description herein, may suggest themselves to one of ordinary skill in the art without departing from the spirit of the present invention or the scope of the appended claims.

The d50 particle size, or median particle size, refers to the particle size for which 50% of the sample by weight has a smaller size and 50% of the sample has a larger size. Particle size measurements were determined by laser diffraction in accordance with ISO 13320 using a Beckman Coulter LS 13 320 Single-Wavelength Laser Diffraction Particle Size Analyzer.

BET surface areas were determined using the BET nitrogen adsorption method of Brunauer et al., J Am. Chem. Soc., 60, 309 (1938) using a Micromeritics TriStar II Surface Area and Porosity Analyzer.

### Examples 1-6

Table I summarizes the EVA/LLDPE formulations of Examples 1-6, in which 10 wt. % of a FR synergist was used for Examples 1-3 and 5-6. Example 1 used a triazine zinc phosphate compound (prepared as described below) as the FR synergist, Example 2 used Satire® 400 as the FR synergist, Example 3 used a silane surface treated Safire® 400 as the FR synergist, Example 5 used melamine polyphosphate as the FR synergist, and Example 6 used ammonium polyphosphate as the FR synergist. Example 4 used ATH (d50 of ˜2 μm and BET of ˜4 m²/g) without a FR synergist, and the amount of ATH was increased from 49.82 to 59.82 wt. % for this example.

The triazine zinc phosphate compound used as the FR synergist in Example 1 was prepared as follows. Water and melamine were combined in a main reactor vessel and stirred at 80-85° C. to form a slurry of 10-15 wt. % solids. In a second reactor vessel, water and zinc oxide were mixed at 80-85° C. to form a slurry of 10-15 wt. % solids. Phosphoric acid (75%) was added slowly to the zinc oxide slurry (approximate molar ratio of phosphoric acid to zinc oxide was 2:1) while mixing, and the addition rate was decreased as needed to control the exothermic reaction, which formed zinc dihydrogen phosphate. After addition of phosphoric acid was complete, the contents of the second reactor vessel were mixed for at least 30 min at 95-99° C. and until the zinc dihydrogen phosphate solution was clear and had a pH of less than ˜1.7. Subsequently, the zinc dihydrogen phosphate solution in the second reactor vessel was cooled to below ˜85-88° C. Next, the zinc dihydrogen phosphate solution in the second reactor vessel was transferred to the main reactor vessel (containing the melamine slurry; the approximate molar ratio of zinc to melamine was 1:2), and the contents of the main reactor vessel were mixed for ˜4-6 hours. The reaction product was dried at temperature of 120° C. for 24 hours to form the solid triazine zinc phosphate compound, which was milled to a d50 particle size of 2.5 μm and a BET surface area of 3.5 m²/g prior to being used in the flame retardant polymer formulation of Example 1.

The Safire® 400 synergist used in the polymer composition of Example 2 was prepared by polymerizing the precursor triazine zinc phosphate compound of Example 1 by subjecting the precursor to conditions of 310° C. and 45 min, as generally described in U.S. Pat. Nos. 8,754,154 and 10,351,776.

The surface treated Safire® 400 synergist used in the polymer composition of Example 3 was prepared by charging 3 lb of Safire® 400 (from Example 2) into a 10-L high speed Henschel mixer with a mixing temperature set at 85-88° C. Mixing speed was set at 1000 rpm for 1 minute to allow addition of the hydrophobic silane surface treatment, in which 1 wt. % of Dynasylan 9116 (hexadecyltrimethoxysilane) was added to the Henschel mixer over 1 minute at 1000 rpm. The Henschel mixer was then increased to 3000 rpm and mixed for 10 minutes, followed by cooling the silane treated Safire® 400 to room temperature.

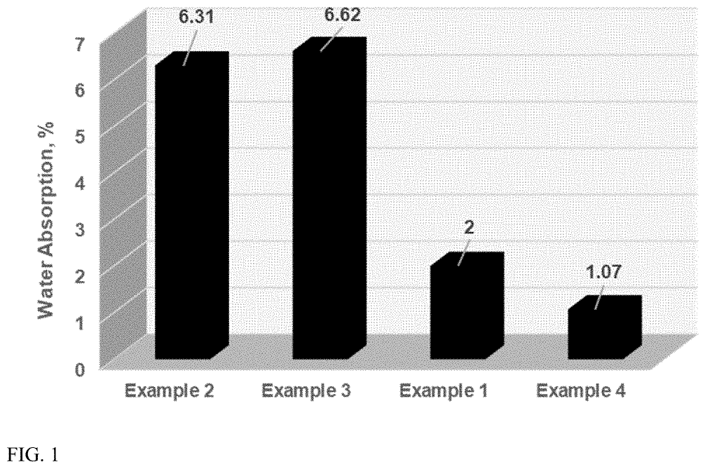

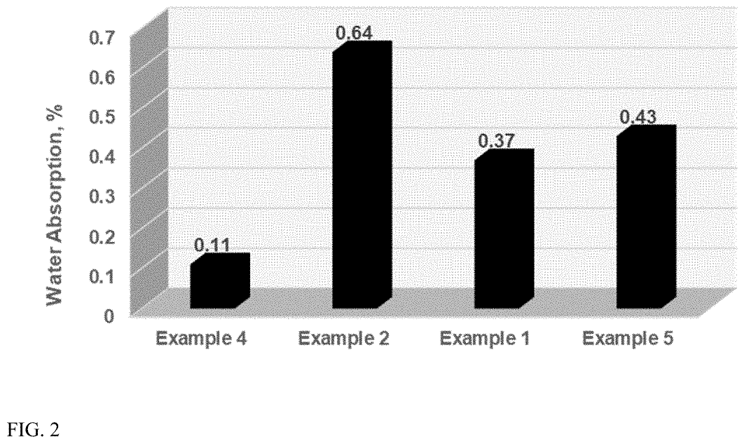

The polymer formulations of Examples 1-6 were evaluated for water absorption performance (via ASTM D570) and wet insulating properties (via ASTM D150). FIG. 1 compares the water absorption properties of the polymer compositions of Examples 1-4 after aging in water at 90° C. and 14 days, while FIG. 2 compares the water absorption properties of the polymer compositions of Examples 1-2 and 4-5 after aging in water at 75° C. and 7 days. As a skilled artisan would readily recognize, phosphorus-based flame retardants are typically not utilized in end-use applications in which water or moisture may be present, due to absorption or pick-up of the moisture. As expected, Example 2 in FIG. 1 had poor performance (over 6 wt. % moisture absorption) and Example 4 (ATH only) had the best performance. In order to reduce the moisture absorption, Example 3 also was evaluated, and this used a hydrophobic surface treatment. Surprisingly, moisture absorption was unaffected by the surface treatment. Example 1, containing the triazine zinc phosphate compound as the FR synergist, had unexpectedly low water absorption — 65-70% better (lower) than that of Examples 2-3. Similar results are shown in FIG. 2, but the aging time was reduced to 7 days and the temperature reduced to 75° C. Example 1, containing the triazine zinc phosphate compound as the FR synergist, had unexpectedly low water absorption — 42% better (lower) than that of Example 2 and 14% better (lower) than that of Example 5 (with melamine polyphosphate as the FR synergist).

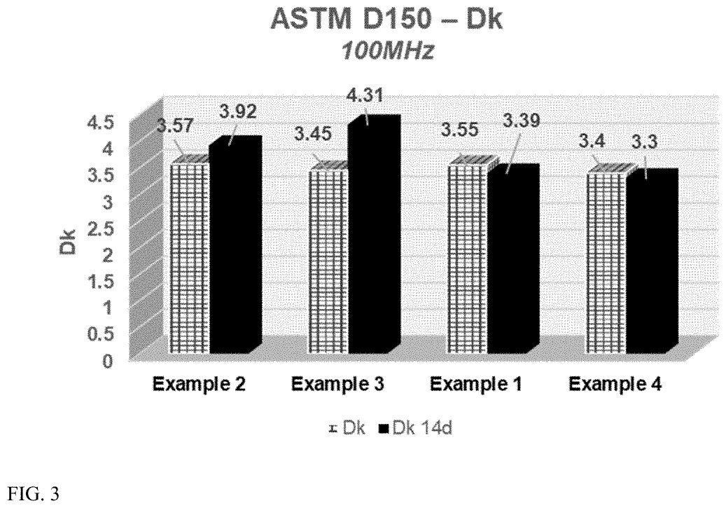

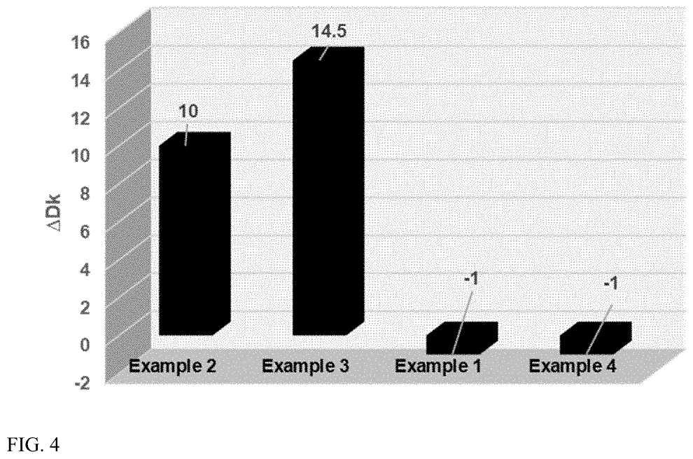

Referring now to ASTM D150 testing and A/C loss properties (wet insulating performance), FIG. 3 compares the dielectric constant (Dk) at 100 MHz before and after aging in water at 90° C. and 14 days for the polymer compositions of Examples 1-4, while FIG. 4 compares the ΔDk, based on the Dk at 100 MHz before and after aging in water at 90° C. and 14 days in FIG. 3, for the polymer compositions of Examples 1-4. These figures show that the initial Dk was very similar for each of the polymer compositions, but after aging, Example 1 was surprisingly comparable to ATH-only Example 4 with a ΔDk of only 1%, whereas Examples 2-3 had ΔDk values of 10-15%.

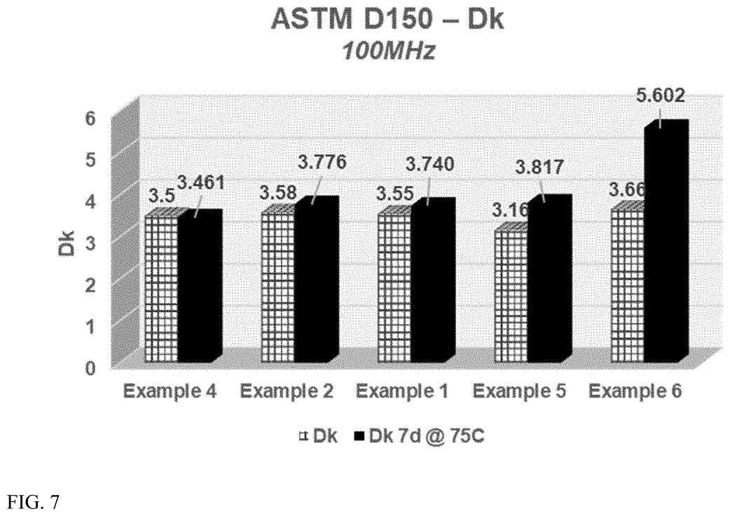

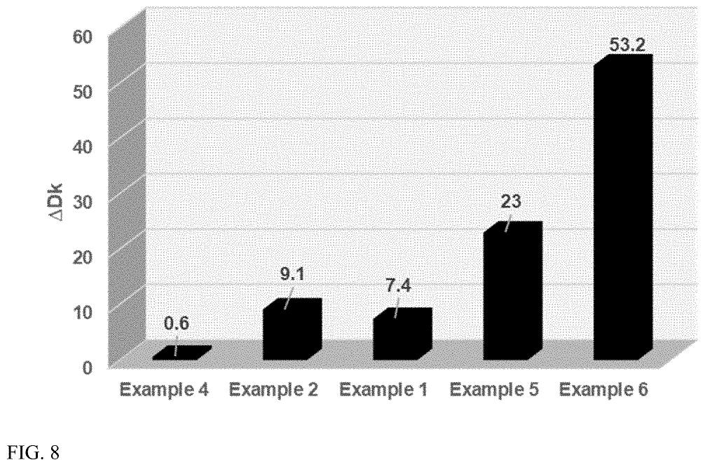

FIGS. 7-8 are similar to FIGS. 3-4, except aging was performed in water at 75° C. and 7 days for the polymer compositions of Examples 1-2 and 4-6. FIGS. 7-8 illustrate that the initial Dk was very similar for each of the polymer compositions, but after aging, Example 1 was superior to Example 2 and far superior to Examples 5-6(melamine polyphosphate and ammonium polyphosphate); other than Example 4, Example 1 had the lowest ΔDk.

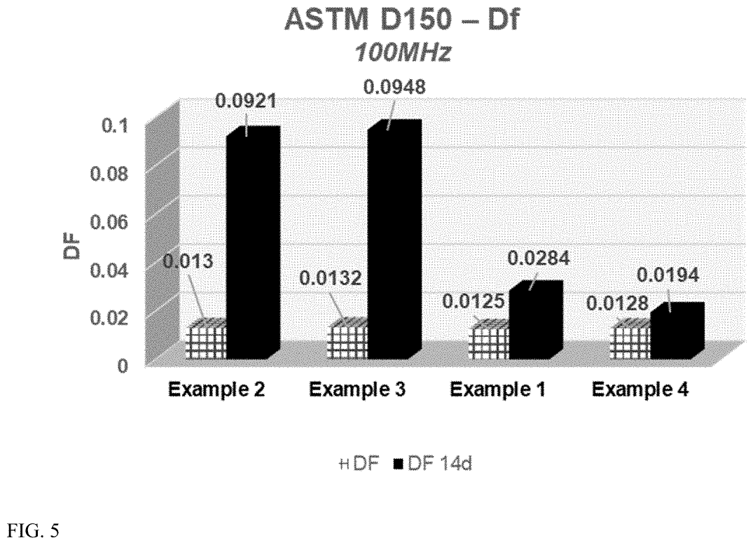

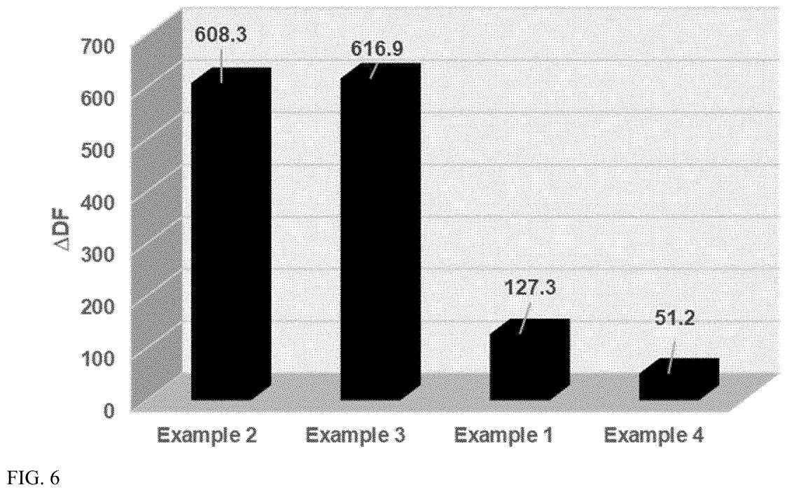

Referring now to FIG. 5, which compares the dissipation factor (DO at 100 MHz before and after aging in water at 90° C. and 14 days for the polymer compositions of Examples 1-4, and FIG. 6, which compares the ΔDf, based on the Df at 100 MHz before and after aging in water at 90° C. and 14 days in FIG. 5, for the polymer compositions of Examples 1-4. These figures show that the initial Df was very similar for each of the polymer compositions, but after aging, Example 1 was surprisingly comparable to ATH-only Example 4, and with a Df after aging that was 70% less than Examples 2-3.

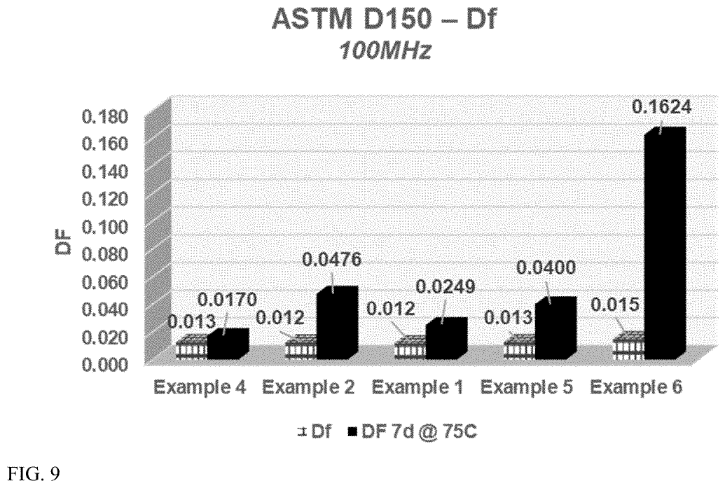

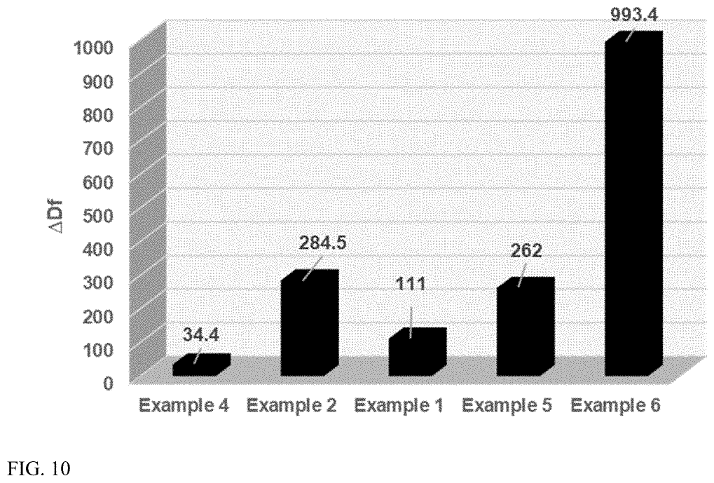

FIGS. 9-10 are similar to FIGS. 5-6, except aging was performed in water at 75 ° C. and 7 days for the polymer compositions of Examples 1-2 and 4-6. FIGS. 9-10 illustrate that the initial Df was very similar for each of the polymer compositions, but after aging, Example 1 was superior to Examples 2 and 5 and far superior to Example 6 (ammonium polyphosphate).

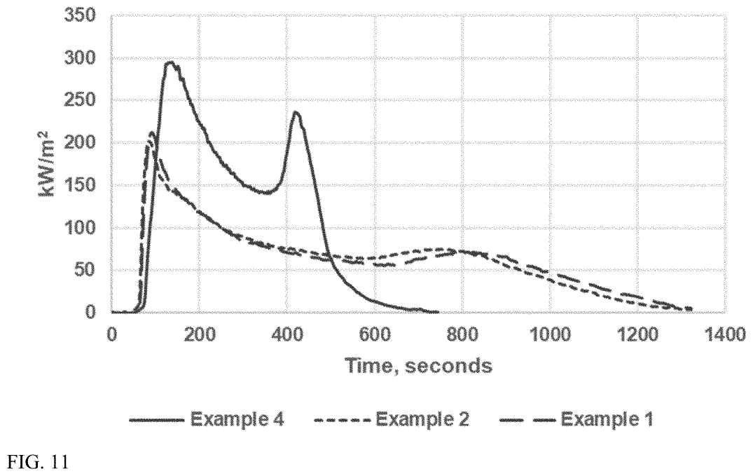

A cone calorimeter (DEATAK CC-2) was used for flame resistance testing on polymer samples following the procedure described in ASTM E1354. Specimens measuring 100 mm×100 mm×0.635 mm were exposed in a horizontal orientation. An external heat flux of 50 kW/m² was used for the experiments. Measured parameters included Time to Sustained Ignition, Peak Rate Release Rate (PHRR), Average Rate of Heat release (RHR) over 300 seconds, Total Heat Released (THR), Avg Effective Heat of Combustion, Avg Mass Loss Rate (10% to 90%), and Avg SEA. Reported data was the average of 3 experiments. Numerical results are summarized in Table II for the polymer compositions of Examples 1-2 and 4, and FIG. 11 provides the heat release rate (HRR) curves for the polymer compositions of Examples 1-2 and 4. The use of the FR synergist in the polymer compositions of Examples 1-2 resulted in a significant improvement in flame retardant performance as compared to the ATH-only polymer composition of Example 4. Importantly, in addition to the water absorption and wet insulative property benefits described above, Example 1 had the same flame retardant performance benefits as that of Example 2.

TABLE I
Flame Retardant Polymer Formulations.

| Ingredient Description | Wt. % |
|---|---|
| EVA 28% VA content | 27.52 |
| LLDPE | 7.58 |
| ATH Martinal 104 LEO | 49.82 |
| FR Synergist | 10 |
| Compatibilizer | 2.39 |
| Compatibilizer | 2.39 |
| Antioxidant | 0.3 |
| Total | 100 |

TABLE II
Heat Release Rate Data.

| Example | Ex 4 | Ex 2 | Ex 1 |
|---|---|---|---|
| Time to Sustained Ignition | 74 | 62 | 65 |
| Peak Rate of Heat Release | 297 | 207 | 213 |
| Average RHR over 300 seconds | 192 | 119 | 119 |
| Total Heat Released | 82 | 84 | 84 |
| Avg Effective Heat of Combustion | 26 | 27 | 26 |
| Avg Mass Loss Rate (10% to 90%) | 7 | 3 | 3 |
| Avg SEA | 350 | 177 | 161 |

The invention is described above with reference to numerous aspects and specific examples. Many variations will suggest themselves to those skilled in the art in light of the above detailed description. All such obvious variations are within the full intended scope of the appended claims. Other aspects of the invention can include, but are not limited to, the following (aspects are described as “comprising” but, alternatively, can “consist essentially of” or “consist of”):

Aspect 1. A polymer composition (or formulation) comprising:

(a) a polymer; and

(b) a triazine metal phosphate compound having formula (I):

(A−H)ₐ⁽⁺⁾[M_{b}^{m+}(H₂PO₄)ₓ₁⁽⁻⁾(HPO₄)ₓ₂²⁽⁻⁾]^{(a-)}*pH₂O (I);

wherein:

each (A−H)⁽⁺⁾ independently is a triazine derivative having formula (II-1), (II-2) or (II-3):

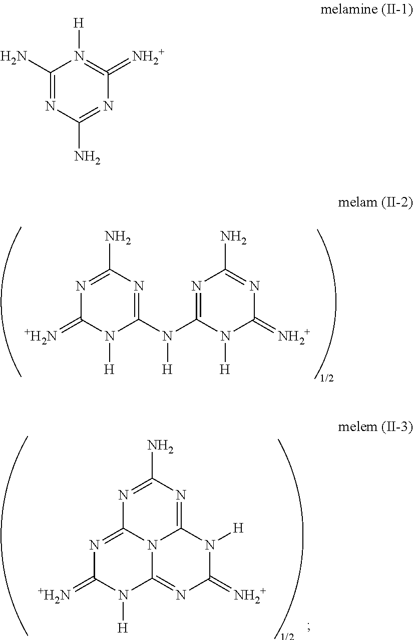

each M independently is Cu, Mg, Ca, Zn, Mn, Fe, Co, Ni, B, Si, Al, Sb, La, Ti, Zr, Ce, V, or Sn;

a is from 1 to 6;

b is from 1 to 14;

m is from 1 to 6;

x₁ is from 1 to 12, x₂ is from 0 to 12, and p is from 0 to 5; and

a+mb=x₁+2x₂.

Aspect 2. The polymer composition defined in aspect 1, wherein the amount of the triazine metal phosphate compound in the polymer composition is any suitable amount, or an amount in any range disclosed herein, e.g., from 1 to 80 wt. %, from 1 to 65 wt. %, or from 1 to 40 wt. %.

Aspect 3. The polymer composition defined in aspect 1 or 2, wherein the polymer composition further comprises an additional flame retardant compound.

Aspect 4. The polymer composition defined in aspect 3, wherein the additional flame retardant compound comprises a metal hydroxide.

Aspect 5. The polymer composition defined in aspect 3, wherein the additional flame retardant compound comprises aluminum trihydrate and/or magnesium hydroxide.

Aspect 6. The polymer composition defined in any one of aspects 3-5, wherein the amount of the additional flame retardant compound in the polymer composition is any suitable amount, or an amount in any range disclosed herein, e.g., from 10 to 80 wt. %, from 20 to 70 wt. %, or from 30 to 65 wt. %.

Aspect 7. The polymer composition defined in any one of aspects 1-6, wherein the amount of the triazine metal phosphate compound in the polymer composition is any suitable amount, or an amount in any range disclosed herein, e.g., from 1 to 40 wt. %, from 1 to 25 wt. %, or from 1 to 15 wt. %.

Aspect 8. The polymer composition defined in any one of aspects 1-7, wherein the polymer composition further comprises an additive, the additive comprising a stabilizer or antioxidant, a lubricant or process aid, a compatibilizer or coupling agent, a filler, a colorant, a rheology modifier, or a curing agent, as well as any combination thereof.

Aspect 9. The polymer composition defined in any one of aspects 1-8, wherein the polymer comprises any suitable polymer, or any polymer disclosed herein, e.g., an elastomer, a thermoplastic, a thermoset, or a combination thereof.

Aspect 10. The polymer composition defined in any one of aspects 1-9, wherein the polymer comprises a polyolefin.

Aspect 11. The polymer composition defined in any one of aspects 1-10, wherein the polymer comprises an ethylene-based polymer, a propylene-based polymer, or any combination thereof.

Aspect 12. The polymer composition defined in any one of aspects 1-11, wherein the polymer comprises a polyethylene (e.g., an ethylene homopolymer or an ethylene-based copolymer, such as an ethylene/α-olefin copolymer).

Aspect 13. The polymer composition defined in any one of aspects 1-11, wherein the polymer comprises a polypropylene (e.g., a propylene homopolymer or a propylene-based copolymer).

Aspect 14. The polymer composition defined in any one of aspects 1-11, wherein the polymer comprises an ethylene/vinyl acetate (EVA) copolymer.

Aspect 15. The polymer composition defined in any one of aspects 1-9, wherein the polymer comprises a natural rubber (NR), an epoxidized natural rubber (ENR), a synthetic cis-polyisoprene (IR), an emulsion styrene butadiene rubber (ESBR), a solution styrene butadiene rubber (SSBR), a polybutadiene rubber (BR), a butyl rubber (IIR/CIIR/BIIR), a chloroprene rubber (CR), a nitrile elastomer (NBR), a hydrogenated nitrile elastomer (HNBR), a carboxylated nitrile elastomer (XNBR), an ethylene propylene rubber (EPM/EPDM), a fluoroelastomer (FPM/FKM), a polyurethane rubber (AU/EU/PU), or any combination thereof

Aspect 16. The polymer composition defined in any one of aspects 1-15, wherein the polymer is crosslinked.

Aspect 17. The polymer composition defined in any one of aspects 1-9, wherein the polymer comprises an epoxy resin.

Aspect 18. The polymer composition defined in any one of aspects 1-9, wherein the polymer comprises a bisphenol A epoxy resin, a bisphenol F epoxy resin, a bisphenol S epoxy resin, a phenol novolac epoxy resin, a cresol novolac epoxy resin, a bisphenol A novolac epoxy resin, a bisphenol F novolac epoxy resin, a diphenylethylene epoxy resin, an epoxy resin having a triazine skeleton, an epoxy resin having a fluorene skeleton, a triphenylmethane epoxy resin, a biphenyl epoxy resin, a xylylene epoxy resin, a biphenyl aralkyl epoxy resin, a naphthalene epoxy resin, a dicyclopentadiene epoxy resin, an alicyclic epoxy resin, or any combination thereof

Aspect 19. The polymer composition defined in any one of aspects 1-18, wherein the polymer composition has a water absorption in any suitable range, or any range disclosed herein, e.g., less than or equal to 6 wt. %, less than or equal to 5 wt. %, less than or equal to 4 wt. %, or less than or equal to 3 wt. %, per ASTM D570 at 90° C. and 14 days in water.

Aspect 20. The polymer composition defined in any one of aspects 1-19, wherein the polymer composition, containing the triazine metal phosphate compound, has a water absorption, per ASTM D570 at 90° C. and 14 days in water, less than that of an otherwise identical formulation containing a polymerized version of the triazine metal phosphate compound.

Aspect 21. The polymer composition defined in any one of aspects 1-20, wherein the polymer composition, containing the triazine metal phosphate compound, has a water absorption, per ASTM D570 at 75° C. and 7 days in water, less than that of an otherwise identical formulation containing a polymerized version of the triazine metal phosphate compound.

Aspect 22. The polymer composition defined in any one of aspects 1-21, wherein the polymer composition has a ΔDk in any suitable range, or any range disclosed herein, e.g., less than or equal to 9%, less than or equal to 7%, less than or equal to 4%, or less than or equal to 2%, wherein ΔDk is the percentage change from an initial Dk to Dk after aging in water at 90° C. and 14 days, in accordance with ASTM D150 at 100 MHz.

Aspect 23. The polymer composition defined in any one of aspects 1-22, wherein the polymer composition has a ΔDf in any suitable range, or any range disclosed herein, e.g., less than or equal to 500%, less than or equal to 400%, less than or equal to 300%, or less than or equal to 200%, wherein ΔDf is the percentage change from an initial Df to Df after aging in water at 90° C. and 14 days, in accordance with ASTM D150 at 100 MHz.

Aspect 24. The polymer composition defined in any one of aspects 1-23, wherein the polymer composition, containing the triazine metal phosphate compound, has a ΔDk (or a ΔDf, or both) that is less than that of an otherwise identical formulation containing a polymerized version of the triazine metal phosphate compound (aging in water at 90° C. and 14 days, in accordance with ASTM D150 at 100 MHz).

Aspect 25. The polymer composition defined in any one of aspects 1-24, wherein the polymer composition has a ΔDf in any suitable range, or any range disclosed herein, e.g., less than or equal to 250%, less than or equal to 225%, less than or equal to 200%, or less than or equal to 150%, wherein ΔDf is the percentage change from an initial Df to Df after aging in water at 75° C. and 7 days, in accordance with ASTM D150 at 100 MHz

Aspect 26. The polymer composition defined in any one of aspects 1-24, wherein the polymer composition, containing the triazine metal phosphate compound, has a ΔDk (or a ΔDf, or both) that is less than that of an otherwise identical formulation containing a polymerized version of the triazine metal phosphate compound (aging in water at 75° C. and 7 days, in accordance with ASTM D150 at 100 MHz).

Aspect 27. The polymer composition defined in any one of aspects 1-26, wherein each M independently is Ca, Mg, Zn, Al, or Sn.

Aspect 28. The polymer composition defined in any one of aspects 1-26, wherein each M is Zn.

Aspect 29. The polymer composition defined in any one of aspects 1-26, wherein the triazine metal phosphate compound is a triazine zinc phosphate compound having at least one of the following formulas:

(A−H)⁽⁺⁾[Zn²⁽⁺⁾(H₂PO₄)⁽⁻⁾(HPO₄)²⁽⁻⁾]*pH₂O

(A−H)⁽⁺⁾[Zn₂²⁽⁺⁾(H₂PO₄)₃⁽⁻⁾]*pH₂O;

(A−H)₂⁽⁺⁾[Zn²⁽⁺⁾(H₂PO₄)₂⁽⁻⁾(HPO₄)²⁽⁻⁾]*pH₂O

(A−H)₂⁽⁺⁾[Zn²⁽⁺⁾(H₂PO₄)₄⁽⁻⁾]*pH₂O;

(A−H)₂⁽⁺⁾[Zn²⁽⁺⁾(HPO₄)₂²⁽⁻⁾]*pH₂O

(A−H)⁽⁺⁾[Zn₂²⁽⁺⁾(H₂PO₄)⁽⁻⁾(HPO₄)₂²⁽⁻⁾]*pH₂O

(A−H)⁽⁺⁾[Zn₂²⁽⁺⁾(H₂PO₄)₃⁽⁻⁾(HPO₄)²⁽⁻⁾]pH₂)

(A−H)⁽⁺⁾[Zn₂²⁽⁺⁾(H₂PO₄)₅⁽⁻⁾]*pH₂O

(A−H)₂⁽⁺⁾[Zn₂²⁽⁺⁾(H₂PO₄)₂⁽⁻⁾(HPO₄)₄^{2(-)]*pH}₂O

(A−H)₂⁽⁺⁾[Zn₂²⁽⁺⁾(H₂PO₄)₄⁽⁻⁾(HPO₄)^{2(-)]*pH}₂O

(A−H)₂⁽⁺⁾[Zn₂²⁽⁺⁾(HPO₄)₃²⁽⁻⁾]*pH₂O

(A−H)₂⁽⁺⁾[Zn₂²⁽⁺⁾(H₂PO₄)₆⁽⁻⁾]*pH₂O;

wherein p is from 0 to 5.

Aspect 30. The polymer composition defined in any one of aspects 1-29, wherein the triazine metal phosphate compound is characterized by any suitable d50 particle size, or a d50 particle size in any range disclosed herein, e.g., from 0.1 to 45 μm, from 0.5 to 20 μm, from 0.5 to 10 μm, from 1 to 6μm, or from 1 to 5μm.

Aspect 31. The polymer composition defined in any one of aspects 1-30, wherein the triazine metal phosphate compound is characterized by any suitable BET surface area, or a BET surface area in any range disclosed herein, e.g., from 0.5 to 30 m²/g, from 0.5 to 10 m²/g, from 1 to 15 m²/g, from 2 to 8 m²/g, or from 2 to 5 m²/g.

Aspect 32. An article of manufacture comprising the polymer composition defined in any one of aspects 1-31.

Aspect 33. The article defined in aspect 32, wherein the article comprises a wire or cable.

Aspect 34. The article defined in aspect 32, wherein the article comprises a printed circuit board.

We claim:

1. A polymer composition comprising:
(a) a polymer; and
(b) a triazine metal phosphate compound having formula (I):
(A−H)ₐ⁽⁺⁾[M_{b}^{m+}(H₂PO₄)ₓ₁⁽⁻⁾(HPO₄)ₓ₂²⁽⁻⁾]^{(a-)}*pH₂O (I);
wherein:
each (A−H)⁽⁺⁾ independently is a triazine derivative having formula (II-1), (II-2) or (II-3): 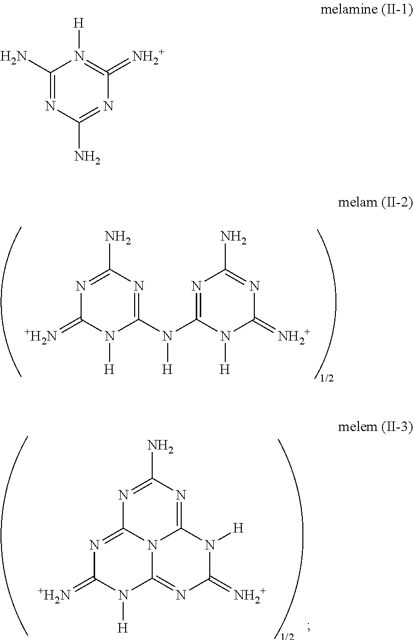
each M independently is Cu, Mg, Ca, Zn, Mn, Fe, Co, Ni, B, Si, Al, Sb, La, Ti, Zr, Ce, V, or Sn;
a is from 1 to 6;
b is from 1 to 14;
m is from 1 to 6;
x₁ is from 1 to 12, x₂ is from 0 to 12, and p is from 0 to 5; and
a+mb=x₁+2x₂; and wherein:
(1) the polymer composition has a water absorption of less than or equal to 6 wt. %, per ASTM D570 at 90° C. and 14 days in water; or
(2) the polymer composition has a ΔDk of less than or equal to 9%, wherein ΔDk is a percentage change from an initial Dk to Dk after aging in water at 90° C. and 14 days, in accordance with ASTM D150 at 100 MHz; or
(3) the polymer composition has a ΔDf of less than or equal to 500%, wherein ΔDf is a percentage change from an initial Df to Df after aging in water at 90° C. and 14 days, in accordance with ASTM D150 at 100 MHz; or
(4) the triazine metal phosphate compound is characterized by a d50 particle size in a range from 0.1 to 45 μm; or
(5) any combination thereof

2. The polymer composition of claim 1, wherein the water absorption is less than or equal to 6 wt. %.

3. The polymer composition of claim 1, wherein the ΔDk is less than or equal to 9%.

4. The polymer composition of claim 1, wherein the ΔDf is less than or equal to 500%.

5. The polymer composition of claim 1, wherein the d50 particle size is in a range from 0.1 to 45 μm.

6. The polymer composition of claim 1, wherein the d50 particle size is in a range from 1 to 6 μm.

7. The polymer composition of claim 1, wherein each M independently is Ca, Mg, Zn, Al, or Sn.

8. The polymer composition of claim 1, wherein each M is Zn.

9. The polymer composition of claim 1, wherein the triazine metal phosphate compound is a triazine zinc phosphate compound having at least one of the following formulas:
(A−H)⁽⁺⁾[Zn²⁽⁺⁾(H₂PO₄)⁽⁻⁾(HPO₄)²⁽⁻⁾]*pH₂O
(A−H)⁽⁺⁾[Zn₂²⁽⁺⁾(H₂PO₄)₃⁽⁻⁾]*pH₂O;
(A−H)₂⁽⁺⁾[Zn²⁽⁺⁾(H₂PO₄)₂⁽⁻⁾(HPO₄)²⁽⁻⁾]*pH₂O
(A−H)₂⁽⁺⁾[Zn²⁽⁺⁾(H₂PO₄)₄⁽⁻⁾]*pH₂O;
(A−H)₂⁽⁺⁾[Zn²⁽⁺⁾(HPO₄)₂²⁽⁻⁾]*pH₂O
(A−H)⁽⁺⁾[Zn₂²⁽⁺⁾(H₂PO₄)⁽⁻⁾(HPO₄)₂²⁽⁻⁾]*pH₂O
(A−H)⁽⁺⁾[Zn₂²⁽⁺⁾(H₂PO₄)₃⁽⁻⁾(HPO₄)²⁽⁻⁾]pH₂)
(A−H)⁽⁺⁾[Zn₂²⁽⁺⁾(H₂PO₄)₅⁽⁻⁾]*pH₂O
(A−H)₂⁽⁺⁾[Zn₂²⁽⁺⁾(H₂PO₄)₂⁽⁻⁾(HPO₄)₄^{2(-)]*pH}₂O
(A−H)₂⁽⁺⁾[Zn₂²⁽⁺⁾(H₂PO₄)₄⁽⁻⁾(HPO₄)^{2(-)]*pH}₂O
(A−H)₂⁽⁺⁾[Zn₂²⁽⁺⁾(HPO₄)₃²⁽⁻⁾]*pH₂O
(A−H)₂⁽⁺⁾[Zn₂²⁽⁺⁾(H₂PO₄)₆⁽⁻⁾]*pH₂O;
wherein p is from 0 to 5.

10. The polymer composition of claim 1, wherein the triazine metal phosphate compound is characterized by a BET surface area in a range from 0.5 to 30 m²/g.

11. The polymer composition of claim 1, wherein the polymer comprises a polyolefin.

12. The polymer composition of claim 1, wherein the polymer comprises an ethylene/α-olefin copolymer, an ethylene/vinyl acetate (EVA) copolymer, or a combination thereof

13. The polymer composition of claim 1, wherein the polymer comprises an elastomer or an epoxy resin.

14. The polymer composition of claim 1, wherein an amount of the triazine metal phosphate compound in the polymer composition is in a range from 1 to 40 wt. %.

15. The polymer composition of claim 1, wherein:
the polymer composition further comprises an additional flame retardant compound;
an amount of the additional flame retardant compound in the polymer composition is in a range from 10 to 80 wt. %; and
an amount of the triazine metal phosphate compound in the polymer composition is in a range from 1 to 25 wt. %.

16. The polymer composition of claim 15, wherein the additional flame retardant compound comprises aluminum trihydrate and/or magnesium hydroxide.

17. The polymer composition of claim 1, wherein the polymer composition further comprises an additive, the additive comprising a stabilizer or antioxidant, a lubricant or process aid, a compatibilizer or coupling agent, a filler, a colorant, a rheology modifier, a curing agent, or any combination thereof

18. The polymer composition of claim 1, wherein the polymer composition, containing the triazine metal phosphate compound, has:
a water absorption, per ASTM D570 at 90° C. and 14 days in water, less than that of an otherwise identical formulation containing a polymerized version of the triazine metal phosphate compound; and/or
a water absorption, per ASTM D570 at 75° C. and 7 days in water, less than that of an otherwise identical formulation containing a polymerized version of the triazine metal phosphate compound.

19. The polymer composition of claim 1, wherein the polymer composition, containing the triazine metal phosphate compound, has:
a ΔDk that is less than that of an otherwise identical formulation containing a polymerized version of the triazine metal phosphate compound, wherein ΔDk is a percentage change from an initial Dk to Dk after aging in water at 90° C. and 14 days, in accordance with ASTM D150 at 100 MHz; and/or
a ΔDf that is less than that of an otherwise identical formulation containing a polymerized version of the triazine metal phosphate compound, wherein ΔDf is a percentage change from an initial Df to Df after aging in water at 90° C. and 14 days, in accordance with ASTM D150 at 100 MHz.

20. The polymer composition of claim 1, wherein the polymer composition, containing the triazine metal phosphate compound, has:
a ΔDk that is less than that of an otherwise identical formulation containing a polymerized version of the triazine metal phosphate compound, wherein ΔDk is a percentage change from an initial Dk to Dk after aging in water at 75° C. and 7 days, in accordance with ASTM D150 at 100 MHz; and/or
a ΔDf that is less than that of an otherwise identical formulation containing a polymerized version of the triazine metal phosphate compound, wherein ΔDf is a percentage change from an initial Df to Df after aging in water at 75° C. and 7 days, in accordance with ASTM D150 at 100 MHz.

21. The polymer composition of claim 1, wherein the polymer composition has a ΔDf of less than or equal to 250%, wherein ΔDf is the percentage change from an initial Df to Df after aging in water at 75° C. and 7 days, in accordance with ASTM D150 at 100 MHz.

22. An article of manufacture comprising the polymer composition of claim 1.
